(19) United States
(12) Patent Application Publication
(10) Pub. No.: US 2021/0055593 A1
(43) Pub. Date: Feb. 25, 2021

(54) LIQUID CRYSTAL CELL ASSEMBLY

(71) Applicant: Flexenable Limited, Cambridge (GB)

(72) Inventors: Jan Jongman, Cambridge (GB); May Wheeler, Cambridge (GB); Barry Wild, Cambridge (GB); Jonathan Huggins, Cambridge (GB)

(21) Appl. No.: 16/999,393

(22) Filed: Aug. 21, 2020

(30) Foreign Application Priority Data
Aug. 21, 2019 (GB) 1911975.9
Aug. 22, 2019 (GB) 1912063.3

(51) Int. Cl. G02F 1/1339; G02F 1/1333

(52) U.S. Cl. CPC G02F 1/13394; G02F 1/133345; G02F 2202/28; G02F 2001/133354; G02F 2001/13398

(57) ABSTRACT

A technique, comprising: assembling together two liquid crystal half-cells; wherein at least one of the two half-cells comprises a support film and an array of spacer structures formed in situ on the support film; and wherein the assembling comprises pressing together the two half-cells with pre-prepared spacer elements dispensed onto at least one of the two half-cells over at least an area shared with the array of spacer structures; wherein the spacer elements provide primary control of the size of a cell gap between the two half-cells, and the spacer structures function to resist compression of the spacer elements.

### CLAIM OF PRIORITY

This application claims priority to Great Britain Patent Application No. 1911975.9, filed Aug. 21, 2019, and Great Britain Patent Application No. 1912063.3, filed Aug. 22, 2019, the contents of which are hereby incorporated by reference in their entireties.

### FIELD OF THE INVENTION

A liquid crystal (LC) cell typically comprises two half-cells defining a cell gap therebetween and liquid crystal material filling the cell gap. Cell gap control can be important for achieving high quality cells.

A scattering of pre-prepared spacer elements, such as spacer balls/beads/fibres, between the two half-cells has been used to define a cell gap of precise thickness between the two half-cells in the finished cell; but the use of ordered arrays of spacer structures built into one or both of the half-cells has the advantage of location control. For the example of a pixelated display device outside the pixel areas, it may be preferred to locate the spacer structures for the active area in black matrix regions between pixel regions.

The inventors for the present application have identified difficulties in controlling the cell gap with such spacer structures.

There is hereby provided a method, comprising: assembling together two liquid crystal half-cells; wherein at least one of the two half-cells comprises a support film and an array of spacer structures formed in situ on the flexible support film; and wherein the assembling comprises pressing together the two half-cells with pre-prepared spacer elements dispensed onto at least one of the two half-cells over at least an area shared with the array of spacer structures; wherein the spacer elements provide primary control of the size of a cell gap between the two half-cells, and the spacer structures function to resist compression of the spacer elements.

According to one embodiment, the spacer structures are sized such that the pressing acts to compress the spacer structures before any compression of the spacer elements.

According to one embodiment, the spacer elements have a height before said pressing of no more than 95% than the height of the spacer structures before said pressing.

According to one embodiment, the spacer structures and the support film exhibit substantially the same Young's modulus.

According to one embodiment, the spacer structures and an insulating layer directly below the spacer structures exhibit substantially the same Young's modulus.

According to one embodiment, the spacer elements exhibit a higher Young's modulus than the spacer structures.

There is also hereby provided a device comprising: two liquid crystal half-cells assembled together; wherein at least one of the two half-cells comprises a support film and an array of spacer structures formed in situ on the support film; and wherein pre-prepared spacer elements are located between the two half-cells over at least an area shared with the array of spacer structures; wherein the spacer elements provide primary control of the size of a cell gap between the two half-cells, and the spacer structures function to resist compression of the spacer elements.

According to one embodiment, the spacer structures and the support film exhibit substantially the same Young's modulus.

According to one embodiment, the spacer structures and an insulating layer directly below the spacer structures exhibit substantially the same Young's modulus.

According to one embodiment, the spacer elements exhibit a higher Young's modulus than the spacer structures.

### BRIEF DESCRIPTION OF THE FIGURES

An embodiment of the invention is described in detail hereunder, by way of example only, with reference to the accompanying drawings, in which:

FIG. 1 illustrates an early stage of a method according to an embodiment of the present invention;

FIG. 2 illustrates the production of a component of FIG. 1;

FIG. 3 illustrates a later stage of the method of FIG. 1; and

FIG. 4 illustrates a yet later stage of the method of FIG. 1.

### DETAILED DESCRIPTION

In one example embodiment, the technique is used for the production of an organic liquid crystal display (OLCD) device, which comprises an organic transistor device (such as an organic thin film transistor (OTFT) device) for the control component. OTFTs comprise an organic semiconductor (such as e.g., an organic polymer or small-molecule semiconductor) for the semiconductor channels.” The technique for the present invention is equally applicable also to the production of LC cells for other kinds of devices, such as adaptive lens devices, etc.

In one example, the technique is used to produce an LC cell for post-assembly flexing/bending into a curved shape, including simple curved shapes with a single bend line and complex curved shapes with more than one bend line, such as S-bends. The one or more bend lines may or may not be parallel to an edge of the cell.

With reference to FIG. 1, an example of a method according to an embodiment of the present invention involves assembling a liquid crystal cell from two pre-prepared components A and B.

In this example, component B comprises a flexible plastics support film (such as a sub-100 micron thickness film of cellulose triacetate (TAC)); a stack 8 of conductor, semiconductor and insulator layers, each formed in situ on the flexible support film 10, and together defining pixel electrodes and electrical circuitry for independently controlling the electrical potential at each pixel electrode via conductors outside the active area of the display device. In this example, this electrical circuitry is active matrix circuitry. The stack 8 defines a respective thin-film-transistor (TFTs) for each pixel electrode. The stack 8 comprises a source-drain conductor pattern and a gate conductor pattern. The source conductor pattern defines: (i) an array of source conductors each providing the source electrode for a respective row of TFTs, and each extending to outside the active display area; and (ii) an array of drain conductors each in contact with a respective pixel electrode. The gate conductor pattern defines an array of gate conductors each providing the gate electrodes for a respective column of TFTs, and each extending to outside the active display area. The terms “row” and “column” together indicate any pair of substantially orthogonal relative directions. Each pixel electrode is associated with a respective unique combination of source and gate conductors, whereby each pixel electrode can be independently addressed via the source and gate conductors.

In this example, the stack 8 includes an organic polymer semiconductor layer formed in situ on the plastics support film 10 by solution processing, which semiconductor layer provides the semiconductor channels for the above-mentioned TFTs. The stack also includes organic polymer insulator/dielectric layers also formed in situ on the plastics support film by solution processing.

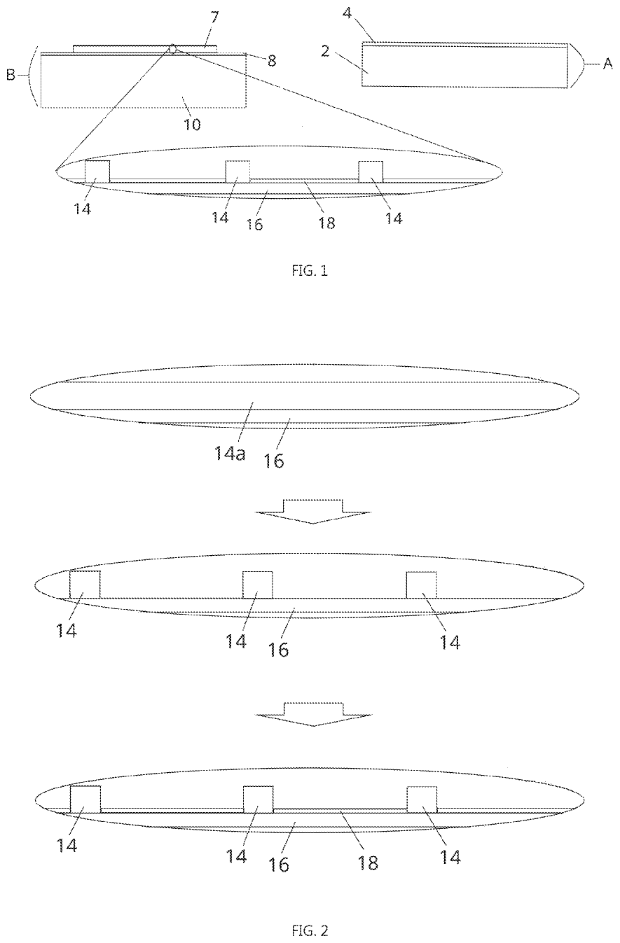

Further layers 7 are formed in situ on the plastics support film 10 over an uppermost isolation layer 16 of the stack 8 to define an array of spacer structures and a liquid crystal alignment surface. In this example, the array of spacer structures are formed in situ on the plastics support film 10 by a simple patterning process (single stage patterning using a simple binary photomask), and the height of each spacer structure 14 is substantially the same across the whole active area (there is no deliberate height differentiation between any of the spacer structures). With reference to FIG. 2, a layer 14a of spacer structure material is formed in situ over the uppermost isolation layer 16 of the electrical circuitry, by a liquid processing technique such as e.g., spin-coating. In this example, the spacer structure material is an organic polymer material (e.g., photoresist material) whose solubility in a developer solvent can be changed by exposure to radiation. The layer 14a of spacer structure material is exposed to a radiation image (negative or positive, depending on the type of photoresist material used for the spacer structure material) of the pattern desired for the array of spacer structures 14, using a simple binary photomask, at a radiation frequency that induces a change in the solubility of the spacer structure material. The resulting latent solubility image is then developed using the above-mentioned developer solvent, to produce the array of spacer structures 14. The location of each spacer structure 14 relative to the underlying electrical circuitry is controllable by controlling the position of the above-mentioned photomask with reference to alignment marks defined by one or more conductor patterns within the stack 8.

In this example, a liquid crystal alignment surface is provided by forming a layer of polyimide material 18 in situ on the workpiece after formation of the array of spacer structures 14, and subjecting the resulting upper surface of the workpiece to a rubbing treatment that produces microgrooves in the exposed surface of the polyimide layer 18. Another example of a technique for producing a LC alignment surface is a photoalignment technique using irradiation instead of mechanical means to achieve a surface that controls the alignment of the LC material.

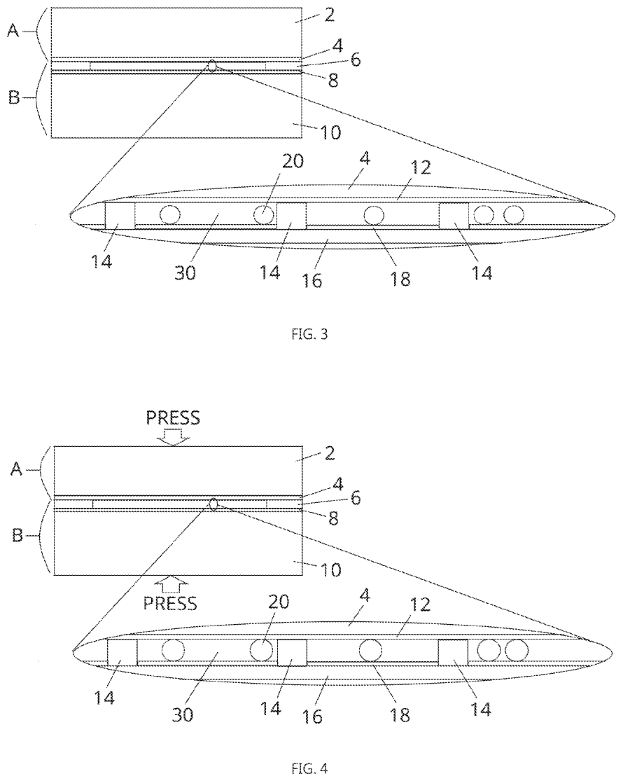

In this example, the second component A also comprises a flexible plastics support film (such as e.g., another sub-100 micron film of cellulose triacetate (TAC)) 2, and provides a colour filter array 4 for the display device. A liquid crystal alignment surface is also provided at one surface of the second component A. In this example, this liquid crystal alignment surface is also provided by forming a layer of polyimide material 12 (shown in FIG. 3) in situ on the flexible support film 2, and subjecting the surface of the polyimide layer 12 to a mechanical rubbing treatment that produces microgrooves in the exposed surface of the polyimide layer 12.

The liquid crystal alignment surfaces of the two components A and B function to control the orientation of the director of the LC material, in the absence of any overriding electric field generated by an electric potential difference between a pixel electrode and a counter electrode (which counter electrode may be part of component A or component B, depending on the type of LC cell).

With reference to FIG. 3: in this example, pre-prepared spacer elements 20 (such as e.g. substantially spherical elements) are dispensed onto an area of the surface of component B shared with the spacer structures 14, before the two components A and B are brought together with the two liquid crystal alignment surfaces facing each other. In this example, spacer balls 20 are sprayed onto the surface of component B. In another example, the spacer balls are dispensed together with the LC material (in the form of a suspension of the spacer balls in the LC material) onto an area of the surface of component B shared with the spacer structures 14, before the two components A and B are brought together with the two liquid crystal alignment surfaces facing each other. In yet another example, the spacer balls 20 are dispensed onto the half-cell at the same time as forming the layer that provides the LC alignment surface. Spacer balls are added to a solution of LC alignment layer material followed by shaking/mixing to distribute the spacer balls as uniformly as possible within the solution. The resulting mixture of solution and spacer balls is dispensed onto the half-cell (by e.g., slit coating or screen coating), followed by drying and baking to remove the solvent and form the layer that provides the LC alignment surface, with the spacer balls anchored to that layer.

In contrast to the spacer structures 14, the location of each individual spacer element 20 on the surface of component B is not controllable. The arrangement of spacer elements 20 on the surface of component B is essentially random.

In this example, the spacer elements 20 and spacer structures 14 are sized relative to each other such that each spacer element 20 does not contact both LC alignment surfaces of both components A and B, when the upper surface of the array of spacer structures 14 of component B first come into contact with component A (i.e., before any forcible pressing of components A and B together). In this example, the starting height (before any compression) of the upper surface of the array of spacer structures 14 is greater than the diameter of the spacer balls 20. The height here refers to the distance above the LC alignment surface. More particularly, the diameter of the spacer balls 20 is about 95% or less of the starting height (before any compression) of the upper surface of the array of spacer structures 14.

With reference to FIG. 4, components A and B are then forcibly compressed together (via relatively rigid glass carriers (not shown) temporarily adhered to the components A and B) to an extent that the spacer balls 20 come into contact with both LC alignment surfaces of components A and B. The spacer structures 14 are then in a compressed state.

With the two components A and B thus forcibly pressed together, the adhesive 6 provided between the two components A and B outside the active display area is cured. After curing is completed, the external force pressing the two components A and B together is removed, and the cured adhesive 6 holds the two components A and B in a state in which the spacer balls 20 remain in contact with both LC alignment surfaces of components A and B, and the spacer structures 14 remain in a compressed state.

LC material may be introduced into the cell gap after bonding the two components A and B together, or LC material 30 may be dispensed onto component B before bringing the two components A and B together. By way of example, FIGS. 3 and 4 show the latter technique.

If the resulting LC cell is later subjected to any forces that tend to compress the spacer balls 20 (such as forcible flexing/bending of the LC cell into curved shapes, particularly into complex curves such as S-bends), the compressed spacer structures 14 act to resist such forces, and reduce the risk of the spacer balls 20 indenting underlying layers and disrupting the function of the stack 8, by e.g., causing breaks in the source and/or gate conductors mentioned above.

The spacer structures 14 formed in situ on the flexible plastics support film 10 are necessarily formed within the constraint of using conditions for the deposition and patterning processes that are compatible with the use of a flexible plastics film for the support substrate 10 and the use of organic polymer semiconductor and insulator layers within the stack 8. Pre-prepared spacer elements can be produced without such processing limitations and can readily exhibit relatively high Young's modulus and more uniform properties. In this example, the spacer elements 20 comprise pre-prepared spacer balls 20 with a Young's modulus higher than the spacer structures 14. The relatively high Young's modulus and reliably uniform properties of the spacer balls 20 both facilitate good control of the cell gap (separation distance between the two LC alignment surfaces of the two components A and B), and thus the LC thickness. At the same time, the ordered and controlled arrangement of in-situ spacer structures 14 acts to prevent excessive compression of the spacer balls 20 and damage to the proper electrical function of the underlying stack 8. In another example, the spacer elements 20 may exhibit a Young's modulus substantially equal to or even lower than the spacer structures 14. A low Young's modulus is preferred for the spacer elements 20 from the point of view of better preventing damage to the proper electrical function of the underlying stack 8, while the above-mentioned reliably uniform properties associated with pre-prepared spacer elements (relative to the spacer structures) facilitates good cell gap control.

In one example, both the photospacer structures 14 (and also the insulator layer 16 directly below the photospacer structures 14) comprise cross-linked epoxy-based photoresist known as SU-8, and exhibit a Young's modulus (YM) of about 2 GPa; and the spacer elements 20 comprise microspheres such as polyvinylchloride (PVC) microspheres (YM=2.4-4.1 GPa), polystyrene microspheres (YM=3-3.5 GPa), polymethylmethacrylate microspheres (YM=2.4-3.4 GPa) and acrylic microspheres (YM=3.2 GPa). The TAC flexible support films exhibit a Young's modulus of about 2.4 GPa. In one example, the spacer elements 20 are made from a material that exhibits good tackiness/adhesive strength for the LC alignment surfaces, and particularly from a material whose tackiness/adhesive strength for the LC alignment surfaces is higher than the tackiness/adhesive strength exhibited by the spacer structures 14 for the opposing LC alignment surface. In one example: before assembling the cell, a surface of the spacer elements 20 is treated or modified so as to increase the adhesive strength exhibited (under the conditions of pressing together the two half-cells) by the spacer elements 20 towards the material (e.g., polyimide material used for the LC alignment layers) providing the surfaces of the half-cells that the spacer elements 20 contact.

The risk of damage to the electrical function of the underlying stack 8 can be further reduced by using for the uppermost isolation layer 16 of the stack 8 a material that exhibits a Young's modulus substantially no lower than the Young's modulus of the spacer balls 20.

In the example described above, the spacer elements 20 and spacer structures 14 are sized relative to each other such that each spacer element 20 does not contact both LC alignment surfaces of both components A and B, when the upper surface of the array of spacer structures 14 of component B first come into contact with component A (i.e. before any forcible pressing of components A and B together). Depending on the nature of the specific spacer elements 20 used, the spacer structures can fulfil the function of preventing damage to the function of the underlying stack 8 even with a starting height comparable to that of the diameter of the spacer balls.

In this example, the LC cell forms part of a pixelated display device, and there is at least one spacer structure at one or more edge of each pixel area, but lower spacer structure densities are also possible. The optimal density for the spacer elements 20 is the minimum density necessary to achieve the desired cell gap control. Higher spacer element densities can negatively increase absorption and/or scattering of light in each pixel region.

As mentioned above, an example of a technique according to the present invention has been described in detail above with reference to specific process details, but the technique is more widely applicable within the general teaching of the present application. Additionally, and in accordance with the general teaching of the present invention, a technique according to the present invention may include additional process steps not described above, and/or omit some of the process steps described above.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A method, comprising:
assembling together two liquid crystal half-cells; wherein at least one of the two half-cells comprises a support film and an array of spacer structures formed in situ on the support film; and wherein the assembling comprises pressing together the two half-cells with pre-prepared spacer elements dispensed onto at least one of the two half-cells over at least an area shared with the array of spacer structures; wherein the spacer elements provide primary control of the size of a cell gap between the two half-cells, and the spacer structures function to resist compression of the spacer elements.

2. The method of claim 1, wherein the spacer structures are sized such that the pressing acts to compress the spacer structures before any compression of the spacer elements.

3. The method of claim 2, wherein the spacer elements have a height before said pressing of no more than 95% than the height of the spacer structures before said pressing.

4. The method according to claim 1, wherein the spacer structures and the support film exhibit substantially the same Young's modulus.

5. The method according to claim 1, wherein the spacer structures and an insulating layer directly below the spacer structures exhibit substantially the same Young's modulus.

6. The method according to claim 1, wherein the spacer elements exhibit a higher Young's modulus than the spacer structures.

7. A device comprising:
two liquid crystal half-cells assembled together;
wherein at least one of the two half-cells comprises a support film and an array of spacer structures formed in situ on the support film; and
wherein pre-prepared spacer elements are located between the two half-cells over at least an area shared with the array of spacer structures; wherein the spacer elements provide primary control of the size of a cell gap between the two half-cells, and the spacer structures function to resist compression of the spacer elements.

8. The device according to claim 7, wherein the spacer structures and the support film exhibit substantially the same Young's modulus.

9. The device according to claim 7, wherein the spacer structures and an insulating layer directly below the spacer structures exhibit substantially the same Young's modulus.

10. The device according to claim 7, wherein the spacer elements exhibit a higher Young's modulus than the spacer structures.

11. The method according to claim 1, wherein the adhesive strength exhibited by the spacer elements for the surfaces of the half-cells that the spacer elements contact is greater than the adhesive strength exhibited by the spacer structures for the surface of the half-cell that the spacer structures contact upon assembling the cell.

12. The method according to claim 1, further comprising: before the assembling, treating or modifying a surface of the spacer elements so as to increase the adhesive strength exhibited by the spacer elements towards a material of the surfaces of the half-cells that the spacer elements contact, under the conditions of pressing together the two half-cells.

13. The device according to claim 7, wherein the adhesive strength exhibited by the spacer elements for the surfaces of the half-cells that the spacer elements contact is greater than the adhesive strength exhibited by the spacer structures for the surface of the half-cell that the spacer structures contact upon assembling the cell.
